(19) United States
(12) Patent Application Publication
(10) Pub. No.: US 2016/0368202 A1
(43) Pub. Date: Dec. 22, 2016

(54) Ultrasonically Sealed Thin Film Seam, Related Methods And Systems For The Manufacture Thereof

(71) Applicant: Austyn D. Crites, Reno, NV (US)

(72) Inventor: Austyn D. Crites, Reno, NV (US)

(21) Appl. No.: 15/186,891

(22) Filed: Jun. 20, 2016

Related U.S. Application Data
(63) Continuation-in-part of application No. 14/746,835, filed on Jun. 22, 2015.
(60) Provisional application No. 62/292,808, filed on Feb. 8, 2016.

(51) Int. Cl. B29C 65/08; B29C 65/02

(52) U.S. Cl. CPC B29C 65/08; B29C 65/02; B29L 2022/022

(57) ABSTRACT

An ultrasonically welded seam formed in thin, semi-crystalline films is provided. In one example embodiment, the seam may include a welded zone flanked by one or more reinforcing perimeter beads, to increase the seam's peel strength and elongation-to-break properties. In one or more embodiments, the seam may be formed by using one or more heat-carrier layers during the ultrasonic sealing of semi-crystalline film layers to generate heat and transfer excess heat across a portion of their surface area and into the semi-crystalline film layers being sealed. The heat-carrier layers enables the film seam to extend wider than the width of the sonotrode and anvil surface areas, creating a reinforcing seam perimeter bead which greatly outperforms prior ultrasonically welded seams of semi-crystalline films.

### CROSS-REFERENCE TO RELATED APPLICATIONS

This application claims the benefit of U.S. Provisional Patent Application No. 62/292,808, filed Feb. 8, 2016, entitled ULTRASONICALLY SEALED HIGH ALTITUDE BALLOON SEAM, the disclosure of which is incorporated by reference herein in its entirety. This application is also a continuation-in-part of U.S. Patent Application No. 14/746,835, filed Jun. 22, 2015, entitled HIGH ALTITUDE BALLOON AND METHOD AND APPARATUS FOR ITS MANUFACTURE, the disclosure of which is also incorporated by reference herein in its entirety.

### TECHNICAL FIELD

The present invention relates to the production of thin film seams, a method of manufacturing thin film seams, and a system for manufacturing such seams.

### BACKGROUND

High altitude balloons include manned and unmanned balloons that may be released at ground level and climb into the troposphere, stratosphere, and even the mesosphere. High altitude balloons are filled with a lifting gas or with air that is maintained at an internal temperature that is higher than the surrounding atmospheric air temperature, thus generating lift. High altitude balloons are often made up of a number of “gores” attached to each other. The term “gore” refers to a tapering sector of a curved surface, such as the tapering panels of a hot-air balloon, a parachute, a beach ball, or a conventional plastic film high altitude balloon. Gored balloons are formed by carefully cutting and heat sealing gores to each other to form the balloon body, often referred to as the envelope. “Non-gored” high altitude balloons are made up of alternatively shaped film panels, such as flat round panels, although the seaming or joining techniques used in both types of high altitude balloons are similar.

High altitude balloon envelopes have been manufactured by heat sealing together tens, dozens, and even up to hundreds of plastic film gores together along the gore perimeters. Most of the plastic films in use include semi-crystalline plastics, with polyethylene (PE) being perhaps the most commonly used plastic high altitude balloon film to date. Conventional heat sealing machines used in the high altitude ballooning industry include continuous band heat sealers, impulse heat sealers, heated wheel sealers, and radio frequency (RF) heat sealers. Ultrasonic sealing, however, has not become a viable sealing technology for high altitude balloon film splicing even though it might, at first glance, seem to be an effective approach.

Various obstacles have kept ultrasonic sealing technology from being an effective tool in forming seams in high-altitude balloons. One obstacle is that conventional ultrasonic technologies generally produce a seam having weak seam strength. Further, the materials being sealed together experience a deterioration of their elongation to break properties. In other words, prior art attempts to ultrasonically weld balloon seams result in seams that either easily peel apart, unzip apart, or snap apart after relatively low force and elongation have been applied (as compared to balloon film seams created with alternative heat sealing technologies). Many major manufacturers of ultrasonic sealing equipment expressly acknowledge (e.g., in their company literature) that semi-crystalline plastics (such as polyethylene) are not suitable for ultrasonic welding. If not stating that semi-crystalline plastics are wholly unsuitable, such companies will instead give semi-crystalline films one of the lowest ratings on the scale of plastic weld suitability for ultrasonic welding processes.

Another major difficulty that has hampered the use of ultrasonic sealing and other semi-crystalline sealing industries has been the narrow margin of error for proper sealing parameters. There is very fine line between either under-welding or over-welding semi-crystalline films with ultrasonic techniques, and these parameters are often thrown into disarray if even the most minor of modifications is made to the structure and/or thickness of the base films being sealed together.

Embodiments of the present invention address these and other problems and enable semi-crystalline plastic films to be successfully welded at high performance standards using ultrasonic processes and techniques. Further, embodiments of the present invention open up the range of suitable ultrasonic parameters that can be used on varying film structures and thicknesses while still obtaining a strong peel resistant and elongatable seal.

### BRIEF SUMMARY OF SOME ASPECTS OF THIS SPECIFICATION

The inventor of the embodiments of the present disclosure has recognized that there are various problems in joining thin film materials, such as semi-crystalline polymer materials. Some of those problems are discussed above and involve issues of seal strength, seal elongatability, and reliability while others involve issues relating to material characteristics and limitations of currently available manufacturing processes. Embodiments of the present invention provide innovative and productive solutions relating to the joining of thin film materials. These solutions are applicable to a variety of industries including, for example, the manufacture of high altitude balloons and the production of consumer and industrial packaging for both food and non-food products.

For example, embodiments of the present specification may make the speed advantages of ultrasonic sealing technology accessible to high altitude ballooning and other industries where thousands of feet of reliable, consistent, and fault-proof seams are required. Where current high altitude balloon sealing technologies, such as continuous band sealing and impulse sealing, may be able to produce, for example, ten or twenty feet of a given seam per minute, embodiments of the present invention may enable the production of seams at a rate of dozens, and even hundreds, of feet per minute. The applicant believes that balloon sealing speeds can be improved by a factor of up to 10 (or more) when utilizing one or more embodiments of the current specification. This significant increase in production, while maintaining (or even improving) seam reliability, can help to drive down unit-balloon envelope costs and reduce overhead and multi-line capital expenditures currently required in the manufacture of high altitude balloons.

Further, at least some embodiments of the present specification enable increased automation in the high altitude balloon manufacturing process. For example, in some applications, analog and digital inputs and outputs of ultrasonic high-frequency vibrations can be controlled on the fly faster and more accurately than currently used continuous band sealers, or hot wheel or impulse sealing machines. Waiting for a band sealer or hot wheel sealer's heating element to increase or decrease temperature at the weld surface will likely be deemed unacceptable in the industry where, in some instances, the near-immediate and precise increase or decrease in ultrasonic frequency vibration adjustments is available as a viable option. For example, where a constant band sealer or hot wheel sealer may require 10 minutes to warm up and 10 minutes to cool down, some ultrasonic welding embodiments can be ready for use in the matter of less than a second.

In addition to the advantages that may be provided in manufacturing efficiency and cost, the resulting seams may provide enhanced reliability and strength. As discussed in further detail below, a seam formed in accordance with some embodiments of the present specification may provide a tensile peel strength that is as strong, or in some cases even stronger, than the tensile strength of the same material in a virgin or non-joined state. In some embodiments, such is accomplished by having a seem having a central weld zone that is flanked by one or more reinforcing perimeter beads as will be further detailed below.

Embodiments of the present invention include seams formed in thin film material layers, systems for forming seams in thin film material layers, and methods of joining thin film material layers. Such material layers may include, for example, semi-crystalline polymers such as polyethylene, polypropylene, polyester, and nylon.

In accordance with one embodiment of the invention, a system is provided for forming ultrasonic welds. The system includes a sonotrode, an anvil positioned adjacent the sonotrode, and at least one heat-carrier layer contacting at least one of a surface of the sonotrode and a surface of the anvil.

In one embodiment, the heat-carrier layer comprises thermally conductive rubber silicone.

In one embodiment, the heat-carrier layer comprises a material selected from the group consisting of: metallic film, amorphous polymeric film, and semi-crystalline polymeric film.

In one embodiment, the heat-carrier layer comprises a material layer comprising polyurethane.

In one embodiment, the heat-carrier layer comprises a material layer comprising polytetrafluoroethylene.

In one embodiment, at least one of the sonotrode and the anvil comprises a rotary wheel.

In one embodiment, the heat-carrier layer includes a continuous strip of material fed between the sonotrode and the anvil.

In one embodiment, the heat-carrier layer includes a circuitous member extending about at least one of the sonotrode and the anvil.

In one embodiment, the system further includes a first pulley, wherein the circuitous member of the first heat-carrier layer extends about the first pulley.

In one embodiment, the system further includes a first compression member adjacent the sonotrode and a second compression member adjacent the anvil.

In one particular embodiment, the at least one heat-carrier layer includes a first heat-carrier layer contacting a surface of the sonotrode and a second heat-carrier layer contacting a surface of the anvil.

In accordance with another embodiment of the invention, a material assembly is provided. The material assembly comprises a first semi-crystalline film layer, a second semi-crystalline film layer and a seam joining the first semi-crystalline film layer and the second semi-crystalline film layer. The seam comprises a welded zone and at least one reinforcing seam bead adjacent the welded zone.

In one embodiment, the seam exhibits a peel tensile strength of between approximately 50% and approximately 120% of a tensile strength of at least one of the first and second semi-crystalline film layers.

In one embodiment, the seam exhibits an elongation-to-break strength of between approximately 50% and approximately 120% of an elongation-to-break strength of at least one of the first and second semi-crystalline film layers.

In one embodiment, the seam exhibits a yield strength of between approximately 50% and approximately 120% of a yield strength of at least one of the first and second semi-crystalline film layers.

In one embodiment, the welded zone includes a patterned weld.

In accordance with another embodiment of the present invention, a method is provided for joining two layers of material. The method comprises overlaying a portion of a first semi-crystalline film on a portion of a second semi-crystalline film, subjecting at least one heat carrier layer to ultrasonic energy to generate heat within the at least one heat-carrier layer, and contacting the overlaid portion of the first and second semi-crystalline films with the at least one heat-carrier.

In one embodiment, the method further comprises forming a seam in the overlaid portion of the of the first and second semi-crystalline films, the seam including a welded zone and at least one reinforcing perimeter bead adjacent the welded zone.

In one embodiment, the act of contacting the overlaid portion of the first and second semi-crystalline films with at least one heat-carrier layer includes contacting the overlaid portion of the first and second semi-crystalline films with at least one layer of thermally conductive silicone rubber.

In one embodiment, the method further comprises applying pressure to the overlaid portion of the first and second semi-crystalline films via the at least one heat-carrier layer subsequent to the act of subjecting the at least one heat-carrier layer to ultrasonic energy.

In one embodiment, the method further comprises subjecting the overlaid portion of the first and second semi-crystalline films to ultrasonic energy.

In accordance with another embodiment of the present invention, another method is provide for joining two layers of material. The method comprises overlaying a portion of a first semi-crystalline film on a portion of a second semi-crystalline film, inducing internal heat in a central weld zone of the overlaid portion of the first semi-crystalline film and the second semi-crystalline film, and inducing external heat in a perimeter of the central weld zone.

In one embodiment, the act of inducing internal heat in a central weld zone includes subjecting the overlaid portion of the first semi-crystalline film and the second semi-crystalline film to ultrasonic energy.

In one embodiment, the act of inducing external heat in a perimeter of the central weld zone includes transferring heat to the perimeter of the weld zone from a heat-carrier layer.

In one embodiment, the method further comprises heat into the heat-carrier layer by subjecting the heat-carrier layer to ultrasonic energy.

In one embodiment, the act of transferring heat to the perimeter of the weld zone from a heat-carrier layer includes transferring heat from a layer of thermally conductive silicone rubber.

In one embodiment, the act of transferring heat to the perimeter of the weld zone from a heat-carrier layer includes transferring heat from a layer of polytetrafluoroethylene.

Additional embodiments, features, and aspects are described below. It is to be understood that the scope of the invention is to be measured by a given claim as issued and not by whether it addresses an issue in the Background section or provides a feature or aspect in this Brief Summary section. It is also noted that the embodiments described herein are not to be considered mutually exclusive of one another and that any feature, aspect, or component of one embodiment described herein may be combined with other features, aspects, or components of other embodiments.

### BRIEF DESCRIPTION OF THE DRAWINGS

The applicant's preferred and some other embodiments are disclosed in association with the accompanying Figures in which:

FIG. 1A shows a conventional rotary ultrasonic sonotrode and anvil sealing pair;

FIG. 1B shows a prior art ultrasonically welded fin seam joining two thermoplastic film layers;

FIG. 2 shows an ultrasonically welded fin seam with two reinforced seam perimeter beads created by the introduction of additional top and bottom heat-carrier layers during the ultrasonic sealing step according to embodiments of the present specification;

FIG. 3A shows a frontal view of a conventional ultrasonic weld vibration direction and the weld zone created by internal friction of two film layers;

FIG. 3B is a frontal view of an ultrasonic welding system depicting improved ultrasonic weld characteristics through the use of two heat-carrier layers to create reinforced seam perimeter beads according to embodiments of the present specification;

FIG. 3C shows a close-up view of the improved ultrasonic film seam of FIG. 3B including the heat-carrier layers, the improved film seam structure, and heat transfer movement from the heat-carrier layers to the internal film layers.

FIG. 4 shows the retention and gradual dissipation of excess heat remaining in the heat-carrier layers and film layers after ultrasonic sealing operations have been completed according to embodiments of the present disclosure;

FIG. 5A is a side view of a virgin (un-spliced/unjoined) film layer in both a relaxed state and in a tensile state;

FIG. 5B shows an end view of a traditionally sealed ultrasonic film seam with low peel strength and low elongation-to-break properties;

FIG. 5C shows an end view depicting the improved peel strength and high elongation-to-break properties of an ultrasonic film seam, with two reinforced seam perimeter beads, according to embodiments of the present specification;

FIG. 6A shows a conventional ultrasonically sealed film seam using a system such as shown in FIG. 1A;

FIG. 6B shows a conventional impulse or band sealed film seam;

FIG. 6C shows an improved ultrasonically sealed film seam, using heat carrier layers to seal two or more layers, according to embodiments of the present specification;

FIG. 7A shows a rotary ultrasonic sonotrode and anvil pair using top and bottom heat-carrier layer strips dispensed from continuous rolls to aid in the welding of thin plastic films (not shown) according to embodiments of the present specification;

FIG. 7B shows a rotary ultrasonic sonotrode and anvil pair using affixed heat-carrier layers around the rotary wheels to aid in the welding of thin plastic films (not shown) according to embodiments of the present specification;

FIG. 7C shows a rotary ultrasonic sonotrode and anvil using a 360 degree rotating heat-carrier band around the rotary wheels and upper and lower pulleys to aid in the welding of thin plastic films (not shown) according to embodiments of the present specification;

FIG. 8A shows two additional upper and lower non-vibrating, compression-only roller pairs placed adjacent the ultrasonic sonotrode and anvil wheel pair used to further compress the reinforcing seam perimeter beads while in a melt state, according to embodiments of the present specification;

FIG. 8B shows an upper and lower non-vibrating, compression-only roller pair placed sequentially after the ultrasonic sonotrode and anvil wheel pair used to further compress the reinforcing seam perimeter beads while in a melt state, according to embodiments of the present specification;

FIG. 8C shows an upper and lower non-vibrating, compression-only pair of cooling bars, placed after the ultrasonic sonotrode and anvil wheel pair used to further compress the reinforcing seam perimeter beads while in a melt state, according to embodiments of the present specification;

FIG. 8D shows a substantially flat ultrasonic seal press with heat-carrier layers affixed to the sonotrode and anvil surfaces, according to embodiments of the present specification;

FIG. 9 is a frontal view of a pet food bag ultrasonically sealed using embodiments of the present invention to create one or more reinforced seam perimeters, according to embodiments of the present specification;

FIG. 10A is a frontal view of a high altitude balloon ultrasonically sealed using embodiments of the present specification to create one or more reinforced seam perimeters, according to embodiments of the present specification;

FIG. 10B shows a close up view of a high altitude balloon film seam of FIG. 10A ultrasonically welded using embodiments of the present specification to create one or more reinforced seam perimeters, according to embodiments of the present specification;

FIG. 11 illustrates a system for joining two sheets of thin film material in accordance with another embodiment of the present specification.

### DETAILED DESCRIPTION

Illustrative embodiments presented herein include embodiments directed toward high altitude balloons, including hermetically sealed superpressure balloons and zero-pressure balloons. However, other balloons and other non-balloon inflatables, consumer packaging goods, and commercial sheeting products may also be manufactured in accordance with principles and embodiments described in the present disclosure.

At least some embodiments of the present specification enable ultrasonically welded semi-crystalline polymer film seams to achieve greatly improved peel seam tensile strength and increased elongation-to-break in material assemblies that may be used in a variety of constructions including high-altitude balloons, consumer packaging, and other products that require heat sealing of two or more semi-crystalline polymer film layers.

In their most basic form, ultrasonic plastic welding machines are conventionally built from an ultrasonic stack and an anvil. The ultrasonic stack includes a converter, a booster, and a sonotrode. The sonotrode is often referred to as an ultrasonic horn. The converter converts an electrical signal into a mechanical vibration. The booster modifies the amplitude of the vibration. The sonotrode applies the mechanical vibration to the parts that are to be welded. The anvil is on the opposing side of the parts (e.g., material film layers) being welded from where the sonotrode is located and enables the high frequency vibration to be directed to the part interfaces. In one embodiment, an electronic ultrasonic generator delivers a high power AC (alternating current) signal with a frequency matching the resonance frequency of the stack. A controller controls the movement of the components, the application of pressure, and the delivery of the ultrasonic energy to the pieces being welded. The pieces being sealed together are often held under pressure during the ultrasonic vibration step, though in other processes a gap may also be run between the sonotrode and the anvil for far-field welding as opposed to near-field welding (where there is direct mechanical pressure between the sonotrode, the film, and the anvil). A multitude of ultrasonic sonotrode and anvil types and shapes are known. Much of the present disclosure will use the example of a rotary (wheel) sonotrode and anvil. However, the present specification is not limited to such rotary wheel configurations as ultrasonic welding can use flat, cylindrical, or irregularly shaped pieces, smooth or patterned sonotrode and anvil surfaces, index sealing and continuous sealing movements, among a variety of other ultrasonic sealing configurations. Many present day ultrasonic sonotrodes and anvils are made from metal and alloy bases, such as titanium, steel, aluminum, etc.

In ultrasonic plastic film welding, high-frequency mechanical vibrations pass though the plastic films and create frictional heat where the film layers come into contact as they pass between the sonotrode and the anvil. There are two primary types of polymers that can be ultrasonically welded: amorphous and semi-crystalline polymers. Amorphous polymers, arranged in random molecular chains, have a wide melt temperature range that enables the material to slowly soften and flow without solidifying too early after minor fluctuations in seal temperature. Because of these properties, amorphous polymers are able to consistently create successful welds under many ultrasonic welding parameters. Examples of amorphous polymers are ABS, Acrylic, Polycarbonate, and PVC. Many of these materials are not commonly used as sealant layers in, for example, the high altitude balloon and packaging goods industries.

The term “semi-crystalline” refers to a polymer with both amorphous and crystalline properties. Semi-crystalline polymers materials have a sharper melting temperature, meaning that they have a much narrower melt temperature range than amorphous polymers and in which they can soften and flow. This makes it harder to achieve a good quality weld without either under-welding or over-welding the films. The molecules of the semi-crystalline polymer films are more orderly and make transmission of the ultrasonic mechanical vibrations difficult to control. Polyethylene, polypropylene, polyester (including polyethylene terephthalate (PET) also known as Mylar®) and nylon are examples of semi-crystalline polymers. As mentioned above, polyethylene is the most commonly used high altitude balloon film material, and thus the at least some embodiments of the present specification may enable great manufacturing advances to be introduced into the industry. Polyethylene (PE) and polypropylene (PP) are two of the most common packaging industry sealant layers, as well, further offering alternative industry advantages of at least some embodiments of the present specification.

Ultrasonic sealing differs from other types of heat sealing in that the heat required to seal two layers together is generated from inside the sealing layers (inside the films being sealed together), rather than heat being introduced by conduction or convection from the outside. Outside heat energy is the primary heat supply for other methods of joining such as constant heat jaws, band sealers, hot wheel sealers, and impulse sealers.

Some embodiments of the present disclosure provide for both internal and external heat to be employed during the ultrasonic welding process. As will be further detailed below, the use of a sonotrode and anvil in sealing technologies is unique in that these components typically remain cold during the ultrasonic sealing process. Some embodiments of the present specification provide for heat generated from within the layers being sealed (by introduction of sonic energy into these material layers) as well as heat introduced from one or more outside sources to combine for a greater strength seal.

In one embodiment, one or more heat-carrier layers, such as thermally conducting silicone rubber strips, are disposed between the sonotrode and the anvil with the materials layers to be sealed then being placed in contact with the one or more heat-carrier layers. The ultrasonic sealing process creates vibrational heat both in the heat-carrier layers and the inner film layers that are to be sealed. Excess heat (generated in the heat-carrier layers) is conducted across the heat carrier layer surface area to be conducted into the internal film layers being sealed. This causes the resulting seam to extend beyond (or be wider than) the “weld width” of the sonotrode and anvil (the “weld width” being the width across which ultrasonic energy is applied by the sonotrode and the anvil). The combination of the internal film heat and the excess heat distributed by the heat-carrier layer provides a seam having a central weld zone (created by the ultrasonic energy or the internal heat) and at least one reinforcing seam perimeter bead at the edge of the central weld zone, the bead being formed from the external, distributed heat applied by heat-carrier layer. The result is, in some embodiments, a much stronger seam than a traditional ultrasonic seam formed without the use of a heat-carrier layer.

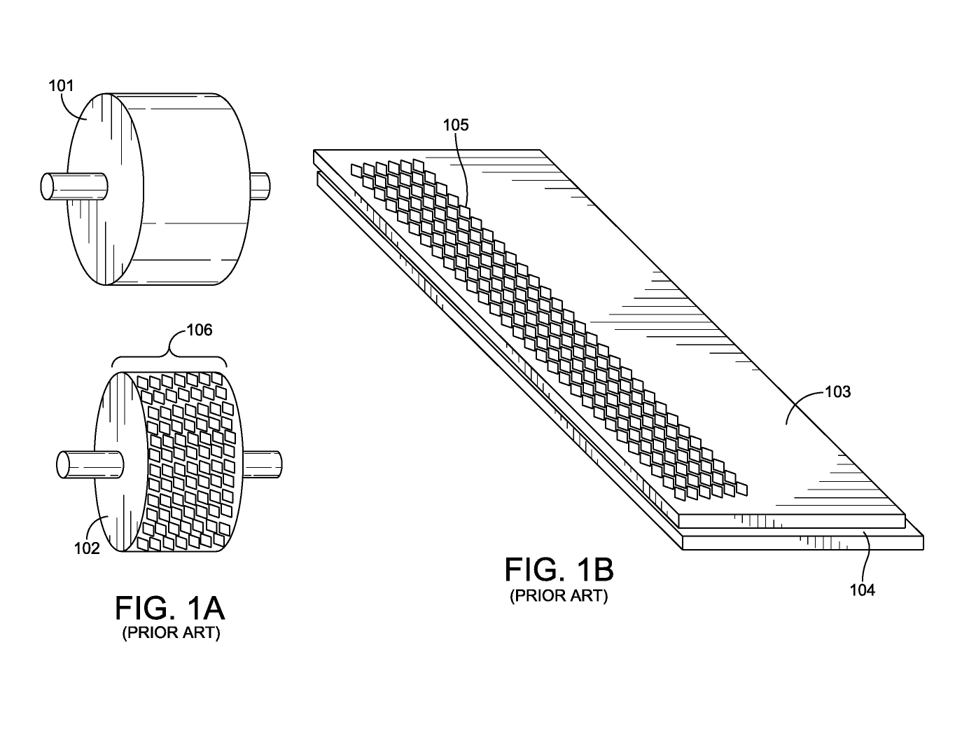

FIG. 1A shows a rotary ultrasonic sonotrode 101 and ultrasonic anvil 102 wheel sealing pair. Two or more thin semi-crystalline polymer film layers 103 and 104, shown in FIG. 1B, such as polyethylene (PE) and/or polypropylene (PP) films, may be passed between the upper sonotrode 101 and lower anvil 102 to create a patterned ultrasonic heat seal 105. Differently patterned (or flat-/no-patterned) ultrasonic seals can also be achieved depending upon the texturing designed into the sonotrode 101 and anvil 102 surfaces. The ultrasonic seam width may be similar to the contact width 106 between the sonotrode 101 and the anvil 102. As previously noted, traditional ultrasonic heat seals on semi-crystalline films, though often hermetic in essence, suffer from low peel strength and low elongation-to-break characteristics as compared to those of the virgin base film and in comparison with the performance of seal tests for other sealing technologies. Other sealing technologies used in an effort to obtain superior performance in semi-crystalline seam peel strength and elongation to break include impulse sealing, band sealing, hot bar, hot wheel, and radio frequency sealing, etc.

Testing procedures relevant to the present disclosure for comparative purposes include but are not limited to ASTM F88 PACKAGE SEAL STRENGTH TESTING and ASTM D882 TENSILE TESTING OF THIN PLASTIC SHEETING. In ASTM F88, a so-called “peel test” is conducted wherein, for example, the right edge (referring to the orientation of the materials in FIG. 1B) of film layer 103 is placed in a first grip of a tensile test machine, the right edge of film layer 104 is placed in an opposing grip of the tensile test machine, and the sample is subjected to a specified tensile force at a specified rate of application until the sample fails, which typically involves the two film layers 103 and 104 “peeling” apart at the seam. The data gathered in the test may then be used to calculate, among other things, the “peel strength” of the seam, sometimes referred to as the peel tensile strength.

In ASTM D882, a tensile test of a single sheet (or film) of material is conducted wherein a first edge is placed in a first grip of a tensile test machine and a second, opposing edge of the material sheet is placed in an opposing grip of the tensile test machine. The material sheet is then subjected to a specified tensile force applied at a specified rate until the sample fails. The data gathered in the test may be used to calculate various properties of the sample including tensile modulus (Young's Modulus) and the tensile strength of the material at failure.

Some embodiments of the current specification are directed toward increasing the peel strength, yield strength, and elongation to break properties of semi-crystalline polymer film seams. In one such embodiment, using peel tests and tensile sheet tests such as described above, the peel tensile strength of an ultrasonically welded seam may be approximately 50% of the tensile strength of the sheet material (i.e., the tensile strength of the virgin material prior to any seams being formed). In another embodiment, the peel tensile strength of an ultrasonically welded seam may be approximately 60% of the tensile strength of the sheet material. In another embodiment, the peel tensile strength of an ultrasonically welded seam may be approximately 100% of the tensile strength of the sheet material. In yet another embodiment, the peel tensile strength of an ultrasonically welded seam may be as much as approximately 120% of the tensile strength of the sheet material. Yield strength characteristics of exhibited ultrasonically welded seams constructed in accordance with embodiments of the present invention may likewise be approximately 50% to approximately 120% of the yield strength characteristics of the virgin sheet material. Elongation-to-break characteristics of exhibited ultrasonically welded seams constructed in accordance with embodiments of the present invention may likewise be approximately 50% to approximately 120% of the elongation-to-break characteristics of the virgin sheet material. Such characteristics may even be exhibited by some embodiments at temperatures as low as approximately −60 to −90° F.

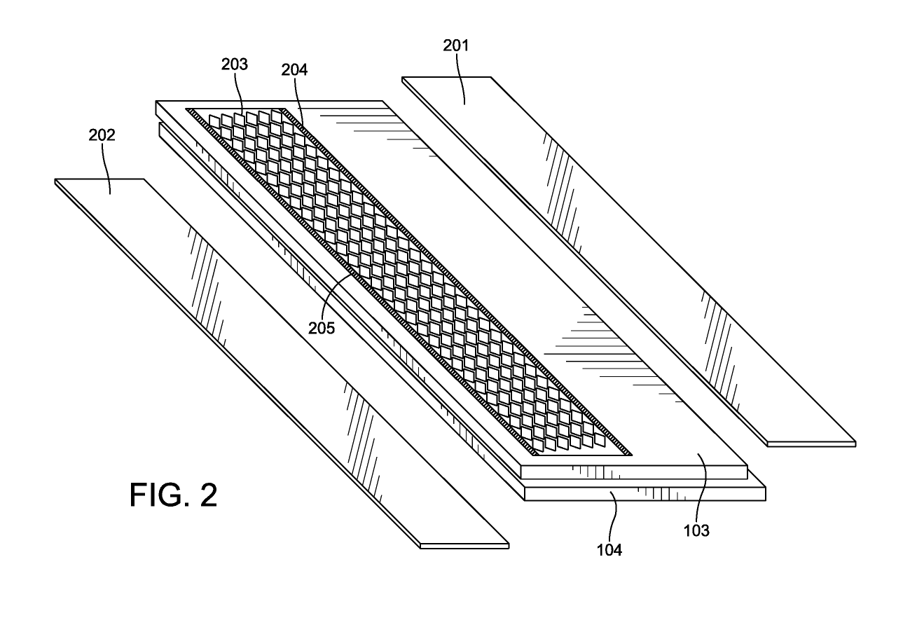

FIG. 2 shows an upper film layer 103 disposed over a lower film layer 104 in accordance with one embodiment of this specification. An upper heat-carrying layer 201 and a lower heat-carrying layer 202 are placed atop and below the film layers 103 and 104, respectively, effectively sandwiching the film layers 103 and 104 between the heat-carrier layers 201 and 202 while the film layers 103 and 104 are being sealed between a sonotrode 101 and an anvil 102.

The heat-carrier layers 201 and 202 may be made from a variety of different materials and exhibit a variety of different thicknesses. In one embodiment, thermally conductive rubber silicone may be used as a heat-carrier layer strip. Thermally conductive rubber silicone has a high temperature resistance, enabling it to transfer heat, generated from ultrasonic vibrations, across a portion of its surface area and toward internal polymer layers with a lower melt temperature. Many grades of thermally conductive rubber silicone have good memory and return back to their previous physical shape after having been subjected to substantial temperature and sealing pressure, thus enabling the material to be reused in additional ultrasonic sealing operations. An additional advantage of thermally conductive rubber silicone for a heat-carrier layer is that the silicone rubber surface can effectively grab and draw materials inward to mitigate against unwanted sonotrode/anvil-to-film layer slippage during sealing operations.

Other suitable materials for use as a heat-carrier layer include thin thermally conductive metallic films, such as copper and aluminum films. Thicker polymeric layers such as amorphous and semi-crystalline films, may also be used as stand-alone heat-carrier layers, or part of multi-layer heat-carrier laminates. Teflon® (polytetrafluoroethylene or PTFE) may be also used as stand-alone heat-carrier layers, or part of multi-layer heat-carrier layers. PTFE coated fiberglass or other PTFE coated and laminated materials may also be suitable heat-carrier layers due to their high temperature resistance and thermal conductivity properties. PTFE and other non-stick coatings may be added to the heat-carrier layers to allow for better release from the inner film layers being sealed together. Polymers such as polyurethane do not adhere well to other plastic films such as polyethylene, so adding a polyurethane layer to a heat-carrier layer, for example, may also ensure good seal release in certain embodiments.

Just as heat-carrier layers may be made from a wide variety of base materials and laminate layers, so too can they exhibit different geometries, cross-sectional profiles and sizes. For example, thermally conductive silicone rubber may be formed in flat strips, rolls of flat sheet material, tubes, wire, cords (solid tubes), belts, among other profile shapes. Likewise, other metallic and polymeric heat-carrier layers may be found in a multitude of different geometries, cross-sectional shapes, materials, and thicknesses to adapt to a required ultrasonic seam performance specification.

The heat-carrier layers 201 and 202 accommodate the transfer of applied heat from the ultrasonic mechanical vibrations (heat generated within the heat-carrier layers from application of ultrasonic energy) across a width of their surface area and transfer a portion of that heat down into the two or more semi-crystalline film layers that are disposed between the heat-carrier layers 201 and 202. FIG. 2 shows an embodiment of the present invention where the top and bottom heat carrier layers 201 and 202 have transferred excess heat substantially evenly down through film layers 103 and 104 to create a more evenly distributed heat seal seam including a weld zone 203 (generated from internal heat) and two reinforcing seam perimeter beads 204 and 205 (generated from application of external heat).

The reinforcing seam perimeter beads 204 and 205 extend beyond the sonotrode 101 and anvil 102 common surface area width 106. By incorporating one or more heat-carrier layers 201 or 202 during ultrasonic sealing of semi-crystalline films 103 and 104, the middle portion of the seam (the weld zone 203) achieves a more evenly distributed heat seal than it would by direct ultrasonic sealing without a heat-carrier layer. The seam perimeter beads 204 and 205 become reinforcing elements of the seam by utilizing excess heat transferred from the heat-carriers 201 and 202 to extend the film seam's width or area of melting beyond the width that a directly welded ultrasonic seam 105 (FIG. 1B) would have provided. In accordance with one embodiment, the resulting seam may be described as having a width of patterned weld (e.g., the weld zone corresponding with the pattern of the anvil 101) and one or more reinforcing perimeter beads at the edge or edges of the patterned weld. In other embodiments, the heat-carrier layer or layers may be sized, configured and arranged such that there isn't a resulting patterned weld, only one or more unpatterned welds.

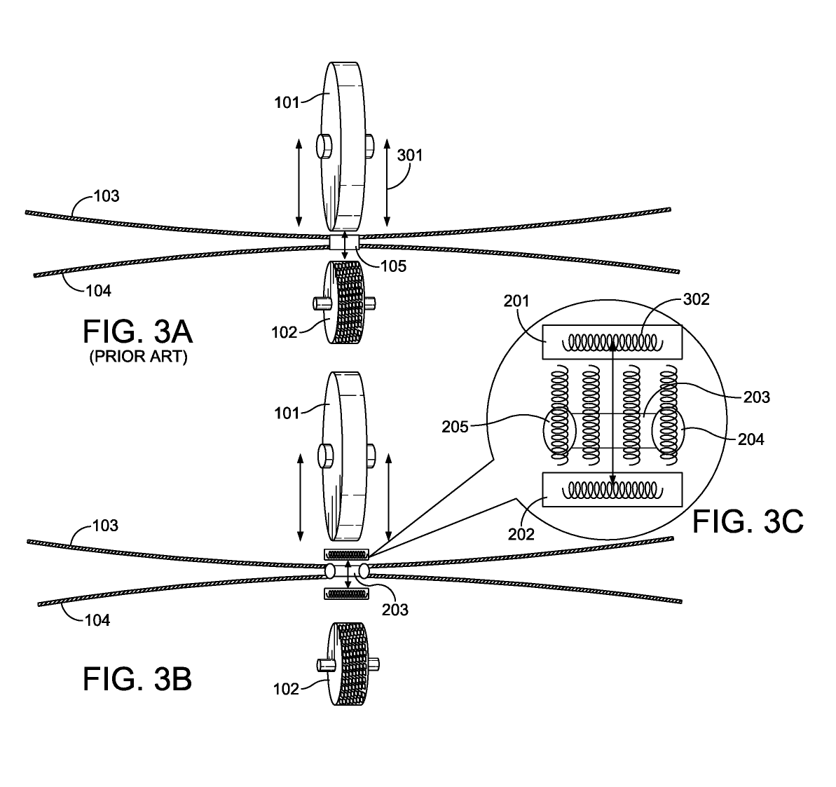

Referring to FIG. 3A, a front view is shown of a conventional welding system as two film layers 103 and 104 are passed between a sonotrode 101 and an anvil 102. The sonotrode 101 vibrates back and forth at a high frequency (e.g., in the vertical line direction 301) and creates internal heat to melt and bond film layers 103 and 104 to create an inferior performance ultrasonic seam 105. In one embodiment, the sonotrode 101 may vibrate at a frequency of between approximately 15 kHz to approximately 70 kHz. In one embodiment, the amplitude of the vibrations produced by the sonotrode may be approximately 13 micrometers (or microns) to approximately 130 micrometers. In other embodiments, the sonotrode 101 may operate outside these ranges in frequency, amplitude or both.

Referring to FIGS. 3B and 3C, shows an embodiment in which a front welding view is depicted. FIG. 3C shows a close-up view of the heat-carrier and film layers of FIG. 3B to help illustrate the distribution of heat within the seam 203 and the formation of the seam as compared to the seam 105 shown in FIG. 3A. As seen in FIG. 3B, two film layers 103 and 104 pass between a sonotrode 101 and an anvil 102 while sandwiched between an upper heat-carrier layer 201 and a lower heat-carrier layer 202, the upper heat-carrier layer 201 being in contact with the sonotrode 101 and the lower heat-carrier layer 202 being in contact with the anvil 102.

The mechanically vibrating sonotrode 101 creates internal heat within the two film layers 103 and 104 and likewise creates heat within the heat-carrier layers 201 and 202. Due to the thermally conductive nature of some or all of the heat-carrier layer's material, excess heat 302 is spread across at least a portion of the heat carrier layers' surface area and down into the film layers 103 and 104 being sealed together. In certain embodiments of the current specification, the heat-carrier layers 201 and 202 act as an insulated oven of sorts, and increase the melt flow of the film layers 103 and 104 as well as the width of the seam 203, providing reinforcing seam perimeter beads 204 and 205 at locations that are laterally beyond the width that the sonotrode 101 and the anvil 102. Thus, at least some such embodiments of the current specification provide major ultrasonic seam performance improvements by protecting the film layers 103 and 104 from excessive heat, distributing heat more evenly across the seam, expanding the heating zone and providing one or more reinforcing beads when welding together two or more semi-crystalline film layers.

It is noted that while various embodiments described herein include two heat-carrier layers (e.g., heat carrier layers 201 and 202), that in certain embodiments, only a single heat-carrier layer may be used. For example, a heat carrier layer may be in contact with a sonotrode with one of the film layers being in contact with an anvil—the single heat carrier layer and the film layers passing between the anvil and sonotrode together. In another embodiment, a heat-carrier layer may be in contact with the anvil while one of the film layers is in contact with the sonotrode—again, the single heat carrier layer and the film layers passing between the anvil and sonotrode together. In yet another embodiment, one or more heat-carrier layers may be in contact with the sonotrode and anvil, receiving heat from the application of ultrasonic energy, while the film layers never directly interact with the anvil and/or sonotrode. Instead, the film layers may interact with the heat carrier layer or layers at a point in time following the one or more heat carrier layers being “heated” by the sonotrode. In such an embodiment, the film layers may be pressed between two previously energized heat-carrier layers, or they may be pressed between a single heat-carrier layer (previously energized) and another anvil or similar structure.

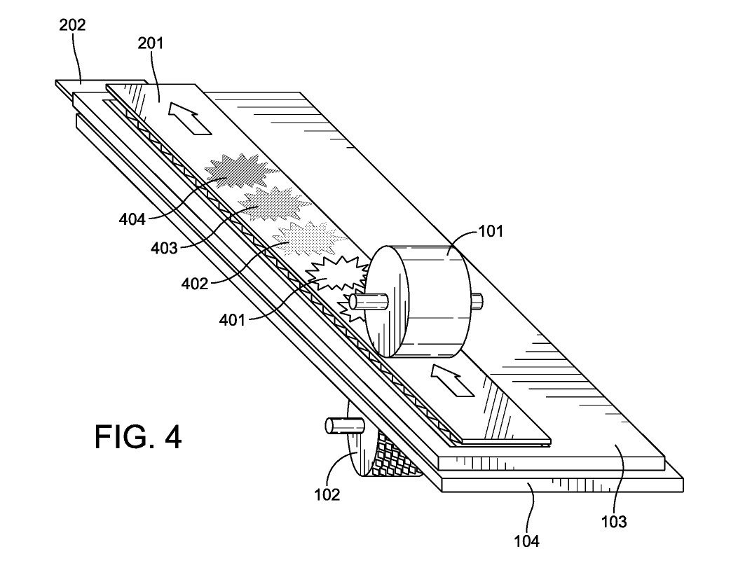

Ultrasonic heat sealing is typically characterized by a rapid cooling of the seam after the material leaves contact with the sonotrode 101 and the anvil 102. FIG. 4 illustrates how embodiments of the current invention utilize heat-carrier layers 201 and 202 during ultrasonic sealing to retain a portion of the heat distributed in the heat-carrier layers 201 and 202 and film layers 103 and 104 as shown in the gradual decreasing of temperature ranges 401,402, 403, 404 (i.e., as the film layers 103 and 104 and heat carrier layers 201 and 202 travel in the direction of the arrows relative to the sonotrode 101 and anvil 102, heat dissipates such that area 404 has a lower temperature that that of are 403, which has a lower temperature than that of area 402, which has a lower temperature than that of area 401).

Such control over sustained heat transfer to the internal layers enables the seam melt to over more area of the width of the seam (e.g., not just across the width where ultrasonic energy is applied between a sonotrode and an anvil) and provides for a wide variety of seam pressure and dwell time configurations to be utilized before the seam has fully resolidified. This can, in some applications, open up a host of opportunities to improvements in the seam strength and elongation to break properties of thin polymer films, most notably semi-crystalline films with the use of ultrasonic sealing technology.

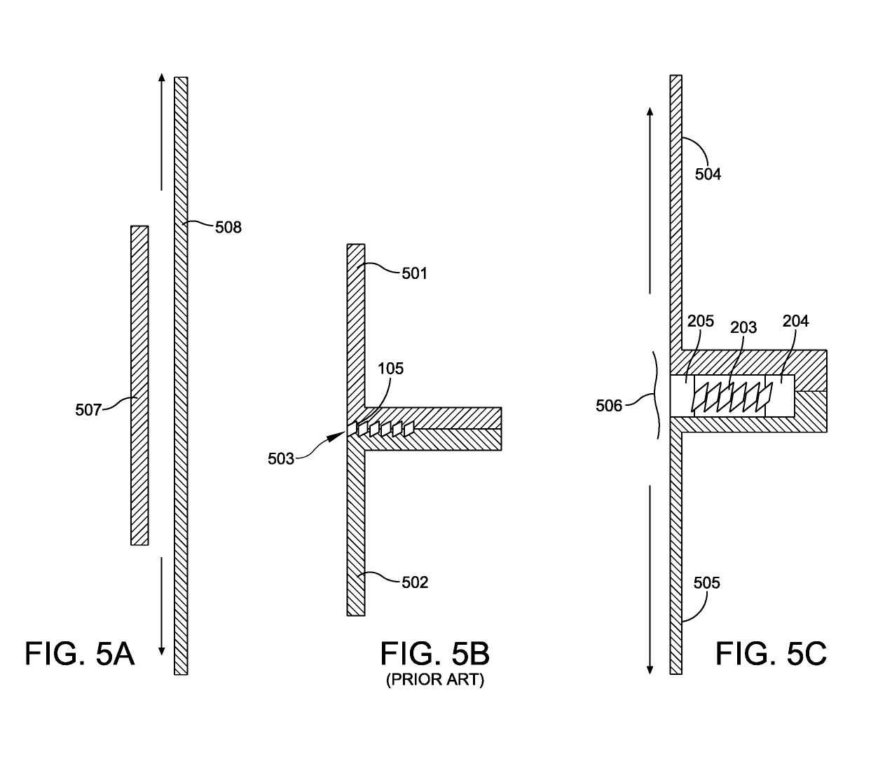

FIGS. 5A, 5B, and 5C provide illustrations to help understand the performance improvements of embodiments of the present invention over traditional ultrasonic semi- crystalline sealing technologies. FIG. 5A illustrates a virgin (unspliced and without a welded seam) semi-crystalline film strip, such as polyethylene, in a relaxed state 507 (not being subject to external forces), as well as in a stretched or tensile state 508 (where tensile forces have been applied to the sheet in the direction of the arrows). Comparison of the film strip in its relaxed state 507 and its tensile state 508 illustrates the general film elongation properties.

FIG. 5B illustrates an ultrasonic fin seal formed between a top film layer 501 and a bottom film layer 502 as the seam undergoes seam peel forces at seam perimeter point 503. Film layers 501 and 502 are formed of the same material as virgin film strip shown in states 507 and 508 of FIG. 5A. When ultrasonically sealing semi-crystalline seams such as seam 105 (created as described with respect to FIG. 1B), a large amount of the virgin film's tensile strength and elongation-to-break performance is lost. Prior art ultrasonic seams 105 will tear, unzip, or snap at the seam perimeter point 503 long before the virgin film's tensile strength or elongation-to-break performance is approached.

By comparison, at least some embodiments of the present specification improve the performance metrics of ultrasonically welded film seams on semi-crystalline films. For example, FIG. 5C illustrates a top film layer 504 and bottom film layer 505 also made from the same material as virgin film strip shown in states 507 and 508 of FIG. 5A. The two film layers 504 and 505 are ultrasonically welded with one or more heat-carrier layers, such as described with respect to the embodiment illustrated in FIG. 4. A strong seam is achieved through the formation of the weld zone 203 and the reinforcing seam perimeter beads 204 and 205 as has previously been described. When the sealed layers 504 and 505 are pulled in opposing directions, as indicated by the directional arrows (such as is done in an ASTM F88 peel test), the seam perimeter joint 506 holds together and elongates, unlike, as shown in FIG. 5G, the much weaker barrier perimeter point 503, which quickly unzips or snaps. The tensile strength and elongation to break characteristics of layers 504 and 505, with common seam 203 illustrated in FIG. 5C, much more approximate the tensile strength and elongation to break of the stretched virgin film 508 in FIG. 5A than can the example in FIG. 5B. In some embodiments, a peel test of the structure shown in FIG. 5C (including the material layers 504 and 505 joined by the welded seam 203) can yield a peel tensile strength that is from about 50% to about 120% of the tensile strength of the sheet of virgin material depicted in FIG. 5A.

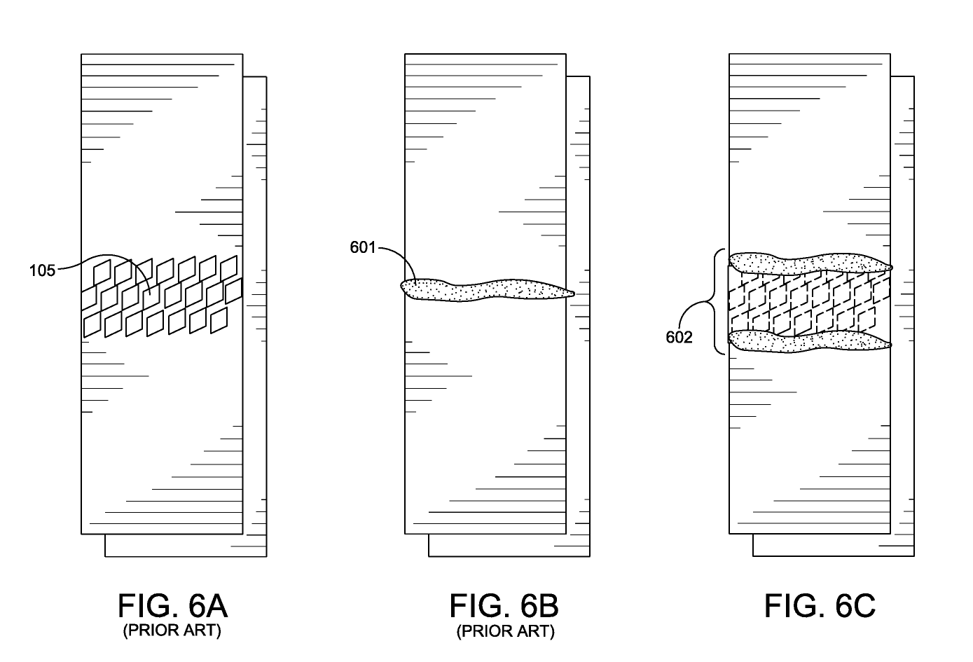

Performance variation between different heat seal types of semi-crystalline films is further illustrated in FIGS. 6A, 6B, and 6C. A traditional ultrasonic film seam 105, such as illustrated in FIGS. 1B and 6A, made by direct contact of the films with a sonotrode 101 and an anvil 102 yields inferior seam peel strength and elongation to break characteristics compared to the seams in FIGS. 6B and 6C. It is noted that the seam 105 made from such direct contact exhibits a melting of material only at locations that generally correspond with the contacting pattern of the anvil 102. On the other hand, FIG. 6B shows a much stronger and elongatable seam 601, which is often used to seal high altitude balloons and consumer packaged goods, but which also is formed by methods other than ultrasonic welding (e.g., by way of heat sealing). Such strong and elongatable seams 601 are regularly utilized on packaging lines that use constant band sealers, impulse sealers, and constant heat bars/jaws for example. Ultrasonic seams 105 formed using prior art methods such as depicted in FIG. 6A are considered inferior to alternative heat seal seams 601 in FIG. 6B in peel strength and elongation-to-break when welding together semi-crystalline films.

Some embodiments of the present specification including the ultrasonic seam 602 depicted in FIG. 6C will approximate (or even surpass) the performance of alternative heat seal seams 601 (FIG. 6B) while providing the unique advantages of ultrasonic seal manufacturing over alternative heat sealing technologies such as speed, seam reliability and consistency.

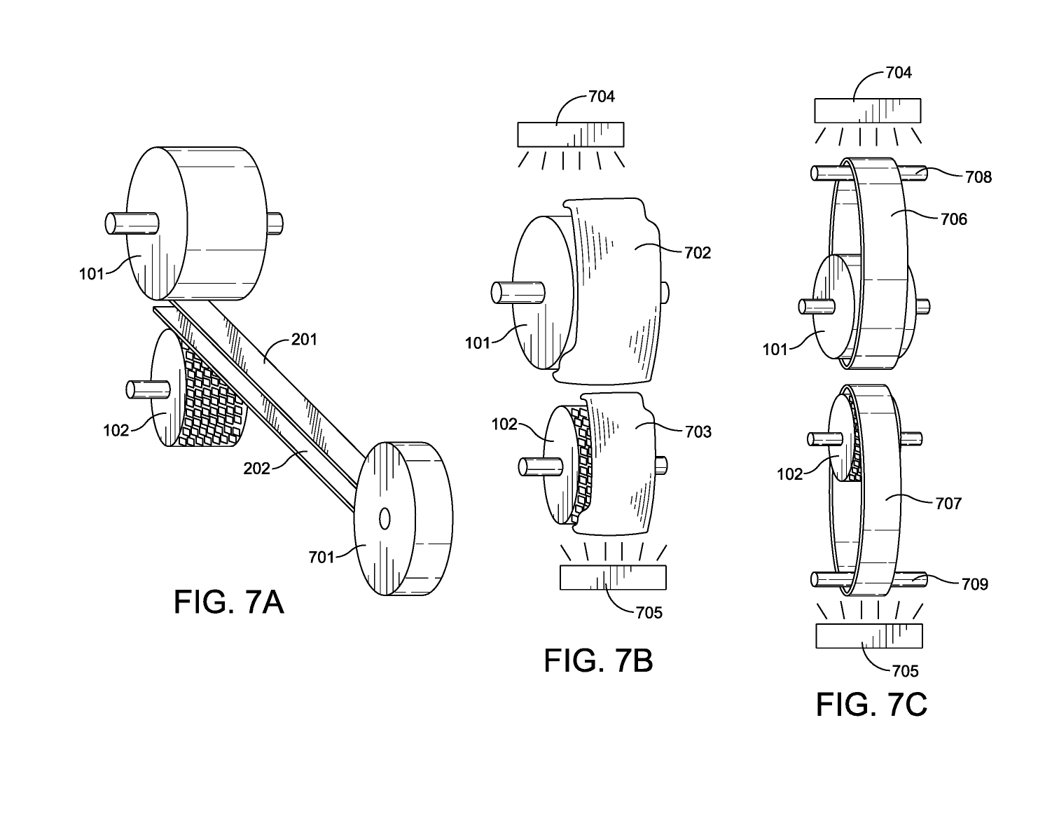

Referring now to FIGS. 7A, 7B and 7C, several examples of heat-carrier layers are shown being introduced to ultrasonic welding of semi-crystalline films. In FIGS. 7A-7C, two or more semi-crystalline film layers may be fed between a sonotrode and an anvil along with one or more heat-carrier layers (e.g., 201, 202, 702, 703, 706 and 707), though the film layers are not shown for purposes of clarity and convenience in illustrating other components. It is noted that while the embodiments shown in FIGS. 7A-7C each depict the use of a pair of heat carrier layers, any of the embodiments shown in FIGS. 7A-7C may be utilized with only a single heat-carrier layer.

FIG. 7A depicts an embodiment in which an upper heat-carrier layer 201 and a lower heat-carrier layer 202 are dispensed from one or more continuous spools 701 to a location between the rotary sonotrode 101 and the rotary anvil 102. Again, while not shown, during operation of the welding system, two or more film layers are positioned between the heat-carrier layers 201 and 202 and the layered structure (including film layers and heat carrier layers) is fed through the sonotrode 101 and the anvil 102 for ultrasonic welding such has been described above. After the heat-carrier layers and film layers exit the sonotrode 101 and anvil 102, and after the formed seam is cooled to desired temperature, the heat-carrier layers 201 and 202 may be peeled off or otherwise removed from the film layers. Such removal may be accomplished by hand or by way of automated machine. The heat-carrier layers 201 and 202 may then be reused, recycled or otherwise disposed of

FIG. 7B depicts an embodiment having (i) a top heat-carrier layer 702 that may be affixed, either permanently or temporarily, to the circumferential surface of the sonotrode 101, and (ii) a bottom heat-carrier layer 703 that may be affixed, either permanently or temporarily, to the circumferential surface of the anvil 102. An ultrasonic welding system, such as shown in FIG. 7B, enables a continuous heat-carrier layer to revolve in a 360 rotational movement with the heat-carrier layer 702 acting as a cover or a coating on the sonotrode 101. Similarly, a continuous heat-carrier layer 703 rotates with the anvil 102 acting as a cover or coating for the anvil, to continually seal the semi-crystalline films without the need to continually dispense additional heat-carrier layers (e.g., such as shown in FIG. 7A). In the case that the heat-carrier layers 702 and 703 remain hot during one full revolution of the rotary wheels of the sonotrode 101 and anvil 102, temperature management systems 704 and 705 may be configured to ensure that the heat-carrier layers 702 and 703 are at their proper operating temperature prior to reengaging the film layers in a subsequent revolution. In one embodiment, the temperature management systems 702 and 703 may include blowers, fans or other forced air mechanisms to induce a cooling stream across a portion of a surface of the heat carrier layers 702 and 703, reducing the temperature of the heat-carrier layers 702 and 703. The temperature management systems 704 and 705 may also include one or more sensors connected to, for example, a PLC (programmable logic controller) or other industrial control device to monitor and control the temperature of the heat-carrier layers. Such a system may also be configured to monitor and control the temperature of welded seam at a given location (e.g., at a certain distance after exiting the sonotrode 101 and anvil 102). In another embodiment, such a control may be used to monitor and control other operating parameters of the system such as the temperature of the sonotrode 101 and/or the anvil 102, the pressure being applied to the layered structure by the sonotrode 101 and the anvil 102, the rotational speed of the sonotrode 101 and anvil (which controls the feed rate of the layered film structure), or the frequency of the ultrasonic vibration output of the sonotrode 101.

While the heat carrier layers 702 and 703 are shown as extending substantially across the entire width of the sonotrode 101 and the entire width of the anvil 102, in other embodiments, the heat-carrier layers 702 and 703 do not necessarily have to extend across the entire surface area of the sonotrode 101 or anvil 102. Rather, the heat-carrier layers may come into contact with only a portion of the width of the circumferential surface of the sonotrode 101 and/or anvil 102. The heat-carrier layers may also comprise several independent layers that collectively cover all of, or only a portion of, the sonotrode and/or anvil depending on a given seal design. For example, in some embodiments, it may be desirable to leave portions of the sonotrode and/or anvil circumferential surfaces area exposed (i.e., not entirely covered by a heat-carrier layer) in order to have direct ultrasonic access to the relevant film portions. Thus, as with any other embodiment described herein, heat-carrier layers may, if desired, fully cover one or more of a sonotrode and/or anvil surface areas in relation to the film layers being sealed, or they may only partially cover the sonotrode and/or anvil surface areas in relation to the film layers being sealed.

Referring to FIG. 7C another embodiment is shown wherein the upper and lower heat-carrier layers take the shape of circuitous, 360 degree rotating bands 706 and 707. The upper rotating heat-carrier band 706 rotates along with the wheel of the sonotrode 101 and around a top band pulley 708. Similarly, the lower rotating heat-carrier band 707 rotates along with rotary wheel of the anvil 102 and around a bottom band pulley 709. Similar to the embodiment described with respect to FIG. 7B, the embodiment shown in FIG. 7C does not require new or “fresh” heat-carrier material to be fed into the system, but rather enables the top and bottom heat-carrier bands 706 and 707 to circuitously loop around pulleys 708 and 709 and continuously, or intermittently, seal film seam lengths. As noted with embodiments described with respect to FIG. 7B, embodiments associated with FIG. 7C may introduce top and bottom temperature management systems 704 and 705 to ensure the heat-carrier bands 706 and 707 are at a desired operating temperature before reengaging the film layers in a subsequent revolution. As with the embodiment described with respect to FIG. 7B (and with any other embodiment described herein), the temperature management systems 704 and 705 may also include sensors and control systems to monitor and control various operating parameters of the ultrasonic welding system.

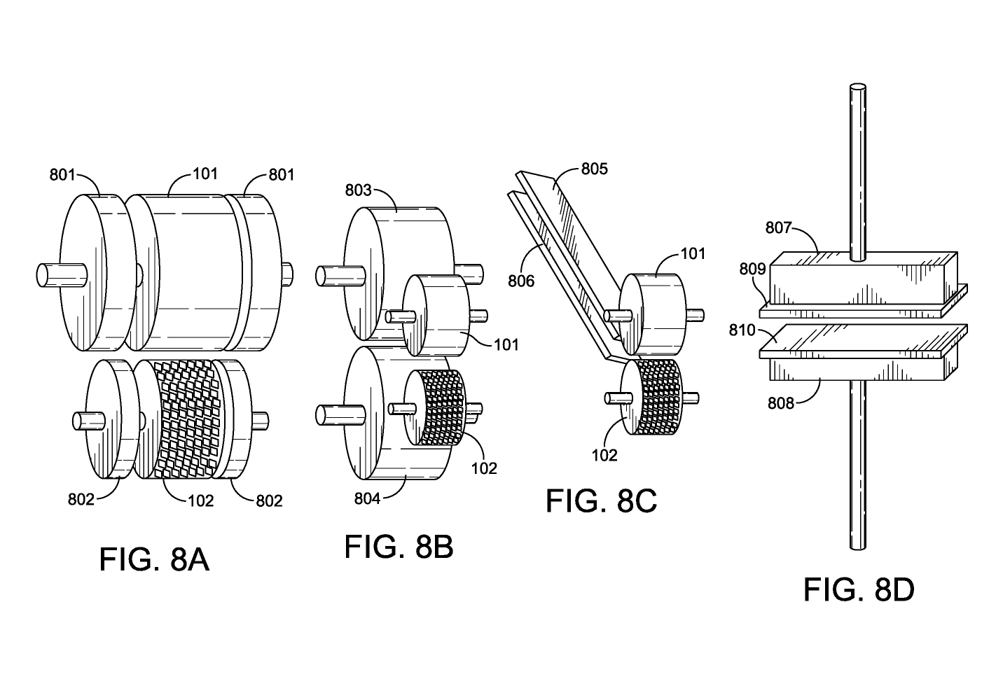

FIGS. 8A, 8B, 8C, and 8D illustrate additional embodiments can incorporate components and techniques to provide additional seam pressure and dwell time either during or after the ultrasonic sealing act by the sonotrode and anvil. In each of FIGS. 8A-8D, two or more semi-crystalline film layers, along with one or more heat-carrier layers, are fed between sonotrode 101 and anvil 102 and associated heat-carrier layers. However, for sake of clarity and convenience in depicting the various components of the ultrasonic welding systems, the film layers and heat-carrier layers are not shown in in FIGS. 8A-8D.

FIG. 8A shows an embodiment in which one or more upper non-vibrating compression rollers 801 are placed laterally adjacent the wheel of the sonotrode 101. Similarly, one or more additional lower non-vibrating compression rollers 802 are placed adjacent the anvil wheel 102. During the sealing operation, the top and bottom non-vibrating compression wheels 801 and 802 can drive additional pressure into the heat-carrier layers at a location at or near the film layers' seam perimeter beads. Such additional direct pressure may help increase the strength of the reinforcing perimeter beads while not interfering with the ultrasonic heating process.

In the embodiment shown FIG. 8A, the upper compression rollers 801 are substantially the same diameter as the wheel of the sonotrode 101 and are located and configured to rotate coaxially with the sonotrode 101. Similarly, the lower compression rollers 802 are substantially the same diameter as the wheel of the anvil 102 and are located and configured to rotate about a common axis with the anvil 102. Also, in some embodiments, the lower compression rollers 802 may be coupled to a common shaft as the anvil 102. In other embodiments, the compression rollers 801 and 802 may be slightly different in diameter than the corresponding wheels of the sonotrode 101 or the anvil. Thus, if the compression rollers 801 and 802 are rotating about common axes as the sonotrode 101 and the anvil 102, the difference in diameter may result in a difference in pressure applied to the mid-section of the seam as compared to the perimeter of the seam where the reinforcing perimeter beads are formed.

In other embodiments, the compression rollers 801 and 802 may be configured to rotate independent of the sonotrode 101 and the anvil 102, rotating on different axes and exhibiting different diameters. In one such an embodiment, pressure applied by the compression rollers 801 and 802 may be separated from, and independently controlled relative to the pressure applied by the sonotrode 101 and the anvil 102. In yet other embodiments, the placement of heat carrier layers may be varied such that all the compression rollers 801 and 802 have heat carrier layers extending across all, part or none of their widths and, similarly, heat carrier layers extending across all, part or none of the widths of the sonotrode 101 and the anvil 102, depending on the design of a particular seam being formed.

Another embodiment is illustrated by FIG. 8B in which one or more non-vibrating upper compression rollers 803 and one or more lower compression rollers 804 are placed behind the sonotrode 101 and anvil 102 to direct additional pressure into the heat-carrier layers at a location at or near the film layers' seam perimeter bead after the films have passed through the sonotrode 101 and the anvil 102. As previously discussed with respect to FIG. 4, some embodiments help control the residual heat and the specified amount of dwell time for the film layers and heat carrier layers after they have passed through the sonotrode 101 and the anvil 102. The compression rollers 803 and 804 may be strategically placed to interact with the film layers and heat carrier layers during the stage of residual heat by providing a desired amount of pressure. Such additional direct pressure and dwell time can help bolster the strength of the seam perimeters while not interfering with the ultrasonic sealing process.

In the embodiment shown in FIG. 8B, the compression rollers 803 and 804 exhibit a greater width than that of the sonotrode 101 and the anvil 102. Such added width may help to further distribute pressure and form a stronger reinforcing perimeter bead. In other embodiments, multiple individual rollers may be used that exhibit a smaller width than that of the sonotrode 101 and the anvil 102, but which are placed desired locations relative to the seam being formed. Thus, for example, compression rollers may be positioned to only engage areas where the reinforcing perimeter beads are formed. In yet another embodiment, multiple sets of compression rollers may be positioned at a variety of locations across the width of the seam such that both the magnitude and time of pressure applied by individual rollers may be tailored across the width of the seam.

FIG. 8C shows an alternative embodiment using upper cooling and/or compression bar 805 and a lower cooling and/or compression bar 806 located sequentially after the sonotrode 101 and anvil 102 to further strengthen the seam perimeters by increasing the sealing pressure and dwell time options. The bars 805 and 806 are configured to apply pressure to the seam and the heat-carrier layers after they have passed from the sonotrode 101 and the anvil 102. It is noted that, as with the embodiment shown in FIG. 8C, temperature (either application of heat or cooling) may be incorporated into any of the compression rollers described above.

Many embodiments have been described in terms of rotary ultrasonic heat seal systems. However the present disclosure is directed to other ultrasonic sealing embodiments as well, such as the non-rotary ultrasonic seal press as depicted in FIG. 8D. FIG. 8D shows an ultrasonic seal press embodiment with a substantially flat sonotrode head 807 and a substantially flat anvil head 808. Affixed, either permanently or temporarily, to the flat sonotrode 807 is an upper heat-carrier layer 809. Affixed, either permanently or temporarily, to the flat anvil 808 is a lower heat-carrier layer 810. By transferring additional heat across at least a portion of their surface area and into the inner film layers, the heat-carrier layers 809 and 810 help melt and reinforce the film seam perimeters similar to what has been described above. In one embodiment, the ultrasonic seal press shown in FIG. 8D may turn off its ultrasonic vibrations while maintaining clamping between the flat sonotrode 807 and the flat anvil 808 so that the heat carrier layers 809 and 810 and the inner films remain at a desired level of pressure (after removal of ultrasonic energy) for a desired amount of time.

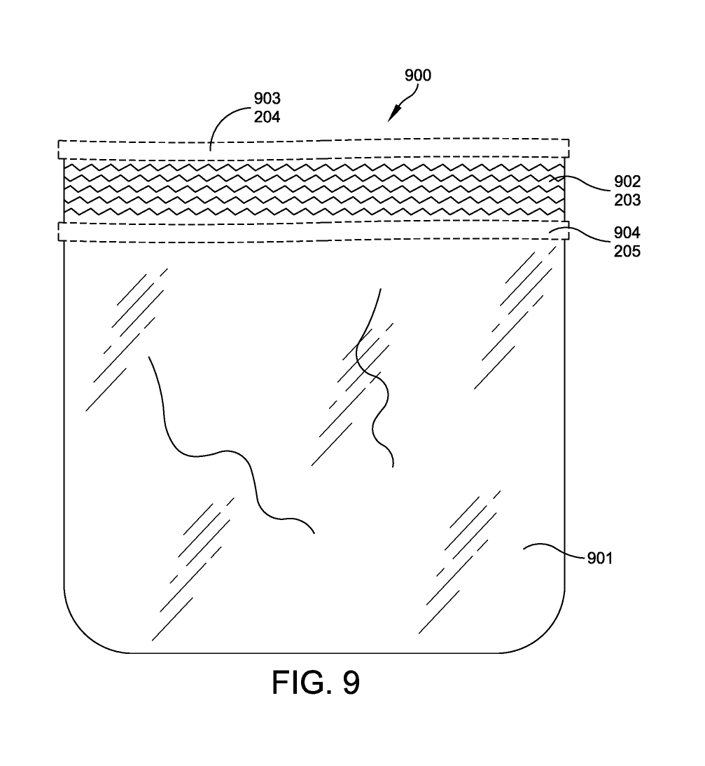

Some embodiments include consumer packaging goods (CPGs) having semi-crystalline sealant layers, such as often is found in laminate film pet food bags 900 illustrated in FIG. 9. The pet food bag 900 is formed from of a flexible packaging film 901. By use of one or more ultrasonic heat-carrier layers during ultrasonic sealing (such as detailed above), an improved seam 902/203 can include at least one of an outward reinforcing seam perimeter bead 903/204 and an inward reinforcing seam perimeter bead 904/205. A common packaging laminate structure used in CPGs may include a plurality of layers including, for example, a first, stronger tensile outer film, such as polyester (PET) or nylon (PA) film, a middle barrier layer film which may be a metallic material or ethylene vinyl alcohol (EVOH), and an inner sealant layer such as polyethylene (PE) or polypropylene (PP). Other packages may be made exclusively from polyethylene (PE) and/or polypropylene (PP), however a large percentage of all CPG flexible packaging has at least one semi-crystalline layer wherein any seals formed with such a material may be greatly strengthened using embodiments of the present invention when employing ultrasonic sealing technology to create seams. While a pet food bag is used as a particular illustration, a variety of different CPGs may be formed using techniques and embodiments of the present invention.

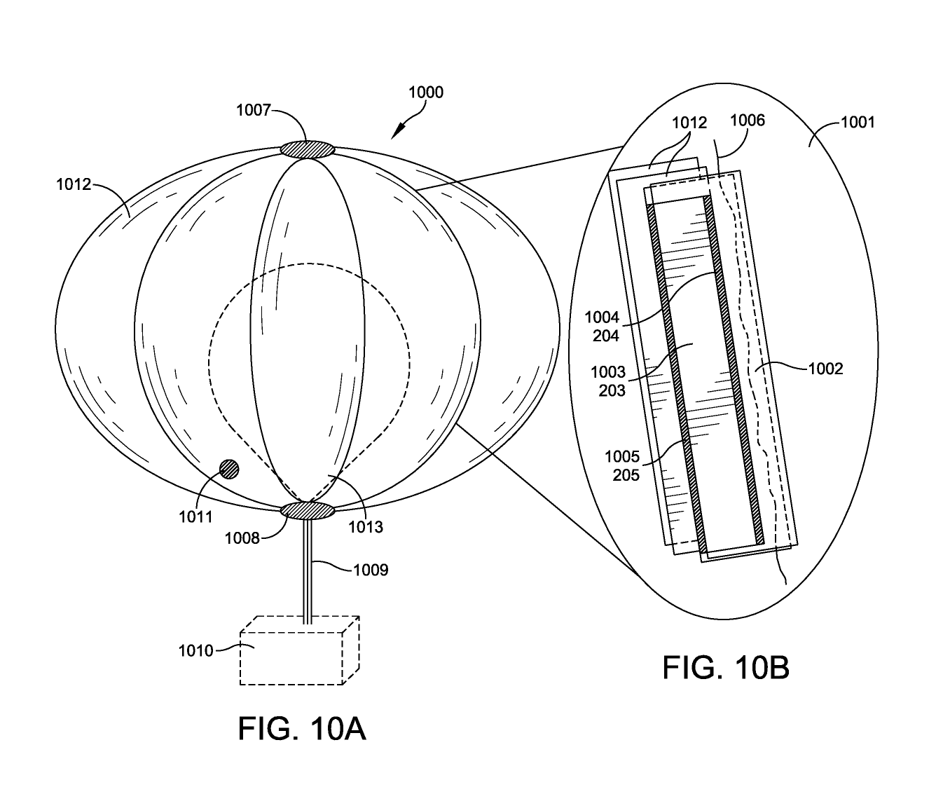

As previously noted, some high altitude balloon embodiments may also achieve improved seam tensile peel strength and elongation-to-break with ultrasonic heat seals formed in semi-crystalline sealant layers, such as often is found in a polyethylene film high altitude balloon 1000 as shown in FIG. 10A. FIG. 10B shows a close-up view of a high altitude balloon 1000 gore seam sub-assembly 1001 in accordance with one embodiment. The balloon gore seam sub-assembly 1001 includes two semi-crystalline balloon film layers 1012, a balloon tendon line 1006, and one or more balloon tendon line film channel layers 1002 sealed together at seam 1003/203. Using embodiments of the present invention to employ heat-carrier layers during ultrasonic sealing steps, the balloon gore seam subassembly 1001 is able to provide superior tensile peel strength and elongation-to-break performance at seam 1003/203 with at least one of an outward reinforcing seam perimeter 1004/204 and an inward reinforcing seam perimeter 1005/205.

High altitude balloon embodiments may include the addition of common balloon components such as top (apex) balloon termination caps and/or tendon termination fittings 1007 and 1008, ballast chambers 1013, ballast control systems, payload lines 1009, payloads 1010, radar reflectors, inflation and deflation valves 1011, cut down systems, tracking systems, parachutes, and solar panels, among many other components and accessories used in the high altitude ballooning industry.

Other examples of products that can benefit from the increased seam strength and increased elongation to break of ultrasonically welded semi-crystalline films, include, but are not limited to, food packaging, agricultural and geomembrane covers, and tarps, among other products that require the mass heat sealing of polyethylene (PE), polypropylene (PP) and other semi-crystalline films. The present disclosure is not limited to semi-crystalline polymer films, as fully crystalline polymers, amorphous polymers and non-plastic materials may also find a substantial increase in bonding strength and/or seam elongation-to-break properties by use of aspects of the present specification. Polyurethane laminated fabric, used in blimps and aerostats for example, has also been found to achieve an increase in seam strength and elongation-to-break performance, using embodiments of the present disclosure during ultrasonic seam welding.

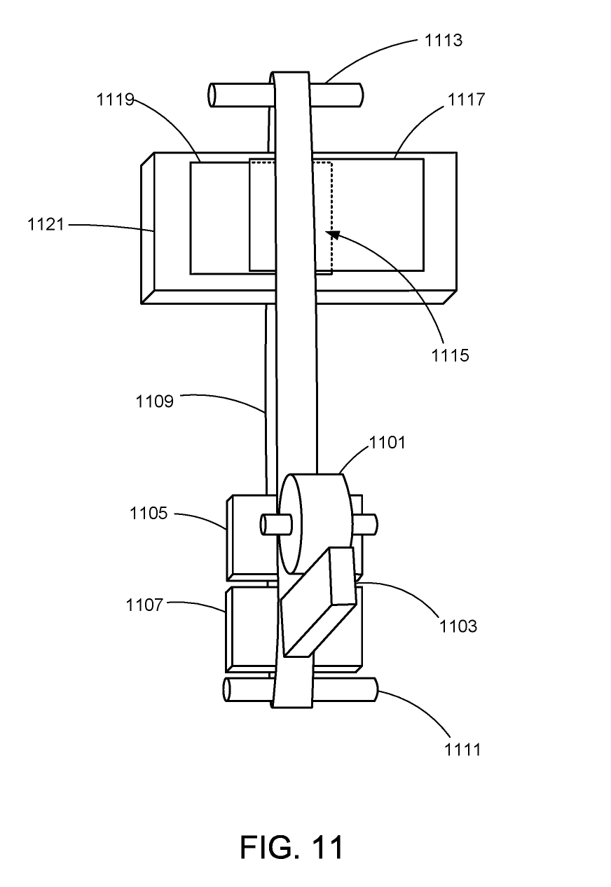

Referring to FIG. 11, a system for joining thin film materials is shown according to another embodiment of the present specification. The system may include a rotary sonotrode 1101, a non-rotary sonotrode 1103 or both. The system further includes one or more anvils 1105 and 1107 associated with the sonotrodes 1101 and 1103. In one embodiment, the anvils 1105 and 1107 may include rotary anvils. In another embodiment, the anvils 1105 and 1107 may include non-rotary anvils (e.g., flat anvils). The system further includes a circuitous heat-carrier layer 1109 that may extend about a first pulley 1111 and a second pulley 1113. The pulleys 1111 and 1113 are configured to drive the heat-carrier layer 1109 such that it comes in contact with one or both of the sonotrodes 1101 and 1103 and their associated anvil(s) 1105 and 1107. Either, or both, of the sonotrodes 1101 and 1103 may subject to the heat-carrier layer 1109 to ultrasonic vibrations to create internal heat within the heat-carrier layer 1109. The heat generated within the heat-carrier layer 1109 may uniformly spread throughout a portion of the heat-carrier layer.

The heat within the heat-carrier layer 1109 may then be transferred to an overlaid portion 1115 of two film layers 1117 and 1119 (e.g., two layers of semi-crystalline polymer material). The two film layers 1117 and 1119 may be placed on a backing structure 1121 so that pressure is applied to the overlaid portion 1115 between the heat-carrier layer 1109 and the backing structure. In such an embodiment, the heat generated by the sonotrode is applied to the overlaid portion 1115 of the film layers 1117 and 1119 only by way of the heat-carrier layer 1109. In other words, the overlaid portion 1115 is not subjected to ultrasonic energy during the joining or welding process.

In other embodiments, various alterations may be made to the system illustrated in FIG. 11. For example, while the backing structure 1121 is depicted as a flat surface, it may instead be formed as a rotary member in some embodiments. In one example embodiment, a pair of compression rollers (similar to compression rollers 803 and 804 illustrated in FIG. 8B) may be used in place of, or in addition to, the backing structure 1121. In yet other embodiments, the heat-carrier layer 1109 may be configured as a continuous sheet feed (e.g., similar to the embodiment described with respect to FIG. 7B). In yet another embodiment, multiple heat-carrier layers may be used in forming a seam in the overlaid portion 1115 of the two film layers 1117 and 1119. Thus, a variety of configurations and combinations of components may be contemplated in providing a system that includes inducing heat into a heat-carrier layer and transferring heat from the heat-carrier layer into thin film materials.

While specific embodiments have been shown by way of example in the drawings and have been described in detail herein. However, it should be understood that the invention is not intended to be limited to the particular forms disclosed. Indeed, features or elements of any disclosed embodiment may be combined with features or elements of any other disclosed embodiment without limitation. This specification includes all modifications, equivalents, and alternatives falling within the spirit and scope of the following appended claims and others supported by this specification.

What is claimed is:

1. A system for forming ultrasonic welds, the system comprising:
a sonotrode;
an anvil positioned adjacent the sonotrode;
at least one heat-carrier layer contacting at least one of a surface of the sonotrode and a surface of the anvil.

2. The system of claim 1, wherein the at least one heat-carrier layer comprises thermally conductive rubber silicone.

3. The system of claim 1, wherein the at least one heat-carrier layer comprises a material selected from the group consisting of: metallic film, amorphous polymeric film, and semi-crystalline polymeric film.

4. The system of claim 1, wherein the at least one heat-carrier layer comprises a material layer comprising polyurethane.

5. The system of claim 1, wherein the at least one heat-carrier layer comprises polytetrafluoroethylene.

6. The system of claim 1, wherein at least one of the sonotrode and anvil comprises a rotary wheel.

7. The system of claim 6, wherein at least one heat-carrier layer includes a continuous strip of material fed between the sonotrode and the anvil.

8. The system of claim 6, wherein the at least one heat-carrier layer includes a circuitous member extending about at least one of the sonotrode and the anvil.

9. The system of claim 8, further comprising a first pulley wherein the circuitous member of the at least one heat-carrier layer extends about the first pulley.

10. The system of claim 1, further comprising a first compression member adjacent the sonotrode and a second compression member adjacent the anvil.

11. The system of claim 1, wherein the at least one heat-carrier layer includes a first heat-carrier layer contacting a surface of the sonotrode and a second heat-carrier layer contacting a surface of the anvil.

12. A material assembly comprising:
a first semi-crystalline film layer;
a second semi-crystalline film layer:
a seam joining the first semi-crystalline film layer and the second semi-crystalline film layer, the seam comprising a welded zone, at least one reinforcing seam bead adjacent the welded zone.

13. The material assembly of claim 12, wherein the seam exhibits a peel tensile strength of between approximately 50% and approximately 120% of a tensile strength of at least one of the first and second semi-crystalline film layers.

14. The material assembly of claim 12, wherein the seam exhibits elongation-to-break strength of between approximately 50% and approximately 120% of elongation-to-break strength of at least one of the first and second semi-crystalline film layers.

15. The material assembly of claim 12, wherein the seam exhibits a yield strength of between approximately 50% and approximately 120% of a yield strength of at least one of the first and second semi-crystalline film layers.

16. The material assembly of claim 12, wherein the welded zone includes a patterned weld.

17. A method of joining two layers of material, the method comprising:
overlaying a portion of a first semi-crystalline film on a portion of a second semi-crystalline film;
subjecting at least one heat-carrier layer to ultrasonic energy to generate heat within the at least one heat-carrier layer;
contacting the overlaid portion of the first and second semi-crystalline films with the at least one heat-carrier layer.

18. The method according to claim 17, further comprising forming a seam in the overlaid portion of the first and second semi-crystalline films, including a welded zone and at least one reinforcing perimeter bead adjacent the welded zone.

19. The method according to claim 17, wherein contacting the overlaid portion of the first and second semi-crystalline films with the at least one heat-carrier layer includes contacting the overlaid portion of the first and second semi-crystalline films with at least one layer of thermally conductive silicone rubber.

20. The method according to claim 17, further comprising applying pressure to the overlaid portion of the first and second semi-crystalline films via the at least one heat-carrier layer subsequent to the act of subjecting at least one heat-carrier layer to ultrasonic energy.

21. The method according to claim 17, further comprising subjecting the overlaid portion of the first and second semi-crystalline films to ultrasonic energy.

22. A method of joining two layers of material, the method comprising:
overlaying a portion of a first semi-crystalline film on a portion of a second semi-crystalline film;
inducing internal heat in a central weld zone of the overlaid portion of the first semi-crystalline film and the second semi-crystalline film; and
inducing external heat in a perimeter of the central weld zone.

23. The method according to claim 22, wherein inducing internal heat in a central weld zone includes subjecting the overlaid portion of the first semi-crystalline film and the second semi-crystalline film to ultrasonic energy.

24. The method according to claim 22, wherein inducing external heat in a perimeter of the central weld zone includes transferring heat to the perimeter of the weld zone from a heat-carrier layer.

25. The method according to claim 24, further comprising inducing heat into the heat-carrier layer by subjecting the heat-carrier layer to ultrasonic energy.

26. The method according to claim 24, wherein transferring heat to the perimeter of the weld zone from a heat-carrier layer includes transferring heat from a layer of thermally conductive silicone rubber.

27. The method according to claim 24, wherein transferring heat to the perimeter of the weld zone from a heat-carrier layer includes transferring heat from a layer of polytetrafluoroethylene.
